(19) United States
(12) Patent Application Publication
(10) Pub. No.: US 2026/0047581 A1
(43) Pub. Date: Feb. 19, 2026

(54) BIODERIVED FERROMAGNETIC NICKEL-FERRITE (NiFe2O4) NANOPARTICLES

(71) Applicant: Imam Abdulrahman Bin Faisal University, Dammam (SA)

(72) Inventor: Mohammad Azam ANSARI, Dammam (SA)

(73) Assignee: Imam Abdulrahman Bin Faisal University, Dammam (SA)

(21) Appl. No.: 18/808,577

(22) Filed: Aug. 19, 2024

(51) Int. Cl. A01N 59/16; A01N 65/42; A01P 1/00

(52) U.S. Cl. CPC A01N 59/16; A01N 65/42; A01P 1/00

(57) ABSTRACT

A method of reducing a biofilm, including mixing a nickel (Ni) salt and an iron (Fe) salt in water to form a solution. The method further includes adding an Aloe vera extract to the solution and stirring for 1 h to 10 h at a temperature of 30 degrees Celsius (° C.) to 80° C. to form a gel. Afterwards, the method includes heating the gel to form a foam, calcining the foam at a temperature of 600° C. to 1000° C. for 1 h to 3 h to form NiFe₂O₄ nanoparticles, and contacting the NiFe₂O₄ nanoparticles with a biofilm on a surface. The NiFe₂O₄ nanoparticles reduce the amount of the biofilm after contact. The NiFe₂O₄ nanoparticles have an average size of 10 nanometers (nm) to 40 nm. The NiFe₂O₄ nanoparticles form aggregates having an average size of 1 micrometer (μm) to 3 μm.

### STATEMENT OF ACKNOWLEDGEMENT

The support of the Deputyship for Research & Innovation, Ministry of Education in Saudi Arabia for funding this research work is gratefully acknowledged.

### BACKGROUND

### Technical Field

The present disclosure is directed to fabrication of nickel-ferrite (NiFe₂O₄) nanoparticles (NPs) and, more particularly, to a method of fabricating NiFe₂O₄ nanoparticles (NPs) using Aloe vera leaf extract.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Presently, a pandemic of antibiotic-resistant microorganisms poses a serious threat to public health globally. Some of the most prevalent pathogens accountable for nosocomial and community-acquired infections are Pseudomonas aeruginosa, Staphylococcus aureus, and Candida albicans. Despite the availability of antibiotics, the rise of antibiotic resistance in microorganisms continues to be a substantial and concerning public health concern. Studies have suggested that antimicrobial resistance is not due to free microorganisms but rather to the microorganisms that exist within biofilms. Biofilms have been shown to have implications in the context of infectious diseases, as well as in the development of infections associated with medical devices.

In general, biofilms are complex communities that exist within the exopolysaccharide layer. Antimicrobial resistance in microorganisms is developed due to the inability of antimicrobials to penetrate the biofilm. Furthermore, the greater tolerance of microorganisms to antimicrobials leads to the development of drug resistance features, while the deactivation of antimicrobial enzymes may pose major threats to human health. As a result, biofilms are challenging to remove and an important factor contributing to drug resistance, recurrent infections, and chronic persistent infections. The formation of a biofilm on a medical device serves as a reservoir for pathogenic cells and exhibits resistance to both drug therapy and the immune response of the host. Therefore, the identification of antimicrobial therapies that can effectively restrict the formation of biofilms is being explored.

Ferrites with distinctive physical characteristics are explored for pharmaceutical and industrial purposes. Within these nanomaterials, nickel-ferrite nanoparticles (NiFe₂O₄ NPs) exhibit properties such as strong overloaded magnetization without any favored ferromagnetic mechanism and good penetration. Further, the potential of NiFe₂O₄ NPs to form magnetized nanospheres, high magnetostriction, and good coupling efficiency make them an alternative for a plurality of applications in medicine. Magnetic NPs have superior characteristics as compared to traditional materials and are favorable for application in a plurality of pharmaceutical industry due to the microstructure and powerful magnetic storage. Furthermore, magnetic NPs are used in biomedical industries, including drug administration, electromagnetic resonance imaging, magneto-thermo drug delivery, hyperthermia, nanosensors, enzymatic therapy of gases, gas detection, and alkane oxidation.

The composition, structure, form, and general properties of magnetic ferrite NPs may depend on the production process. As a result, numerous chemical production methods, such as solvothermal, coprecipitation, hydrothermal, sol-gel, and combustion methods, are used to produce NiFe₂O₄ NPs. However, the abovementioned methods may be costly and detrimental to the environment.

Recently, sustainable and green NP synthesis techniques have been developed to minimize the abovementioned drawbacks. The green synthesis of NiFe₂O₄ NPs has several advantages over other chemical methods such as being environmentally friendly, provides a non-hazardous compatible solvent system, eco-friendly reducing agent, and a non-hazardous gelling agent for stabilizing the nanostructures. The use of plant extracts from leaves, seeds, roots, or flowers in the biosynthetic method of NP manufacturing has been reported. Plant extracts have a number of secondary metabolites, such as polyphenols, alkaloids, sugars, polysaccharides, amino acids, and vitamins which participate in the synthetic process.

Although a few green methods for the fabrication of NiFe₂O₄ NPs have been developed in the past, most of these methods are inefficient and the properties of the NPs vary depending on the plant extract used. Accordingly, a primary objective of the present disclosure is to fabricate NiFe₂O₄ NPs using a sustainable and environmentally friendly green chemistry technique that uses Aloe vera leaf extract as a reducing agent. Another object of the present disclosure is to use such NPs produced by the green method to reduce biofilm formation.

### SUMMARY

In an exemplary embodiment, a method of reducing a biofilm with prepared nickel-ferrite (NiFe₂O₄) nanoparticles (NPs) is described. The method includes mixing a nickel (Ni) salt and an iron salt in water to form a solution. The method further includes adding an aloe vera extract to the solution and stirring for 1 hour (h) to 10 h at a temperature of 30 degrees Celsius (° C.) to 80° C. to form a gel. Furthermore, the method includes heating the gel to form a foam, calcining the foam at a temperature of 600° C. to 1000° C. for 1 h to 3 h to form NiFe₂O₄ nanoparticles, and contacting the NiFe₂O₄ nanoparticles with a biofilm on a surface. As such, the NiFe₂O₄ nanoparticles reduce an amount of the biofilm after contacting the NiFe₂O₄ nanoparticles with the biofilm, where the NiFe₂O₄ nanoparticles have an average size of 10 nanometers (nm) to 40 nm. The NiFe₂O₄ nanoparticles form aggregates having an average size of 1 micrometer (μm) to 3 μm.

In some embodiments, the NiFe₂O₄ nanoparticles are crystalline.

In some embodiments, the NiFe₂O₄ nanoparticles have a spinel structure.

In some embodiments, the NiFe₂O₄ nanoparticles have an irregular shape.

In some embodiments, the NiFe₂O₄ nanoparticles have a spherical shape.

In some embodiments, the NiFe₂O₄ nanoparticles include 15 percent by weight (wt. %) to 25 wt. % 0, 45 wt. % to 55 wt. % Fe, and 30 wt. % to 35 wt. % Ni, based on a total weight of the NiFe₂O₄ nanoparticles.

In some embodiments, the NiFe₂O₄ nanoparticles include phenolic compounds on a surface.

In some embodiments, the method of calcining the foam at a temperature of 600° C. to 1000° C. for 1 h to 3 h removes phenolic compounds from a surface of the NiFe₂O₄ nanoparticles, and the surface of the NiFe₂O₄ nanoparticles has negatively charged hydroxyl groups.

In some embodiments, the NiFe₂O₄ nanoparticles have a saturation magnetization of 25 electromagnetic units per gram (emu/g) to 35 emu/g at 300 K.

In another exemplary embodiment, a method of making the Aloe vera extract is described.

The method includes cutting aloe vera leaves into pieces having a longest dimension of less than 1 cm, mixing the pieces in water and boiling the pieces for at least 5 minutes to form an extract mixture. The method further includes separating the pieces from the extract mixture to form the Aloe vera extract.

In some embodiments, the NiFe₂O₄ nanoparticles have a concentration of 0.125 milligrams per milliliter (mg/mL) to 1 mg/mL of the biofilm during contacting the NiFe₂O₄ nanoparticles with the biofilm.

In some embodiments, the NiFe₂O₄ nanoparticles have a minimum inhibitory concentration (MIC) of 1.6 mg/mL to 2 mg/mL of the biofilm during contacting the NiFe₂O₄ nanoparticles with the biofilm.

In some embodiments, the biofilm includes at least one selected from the group consisting of Methicillin-resistant Staphylococcus aureus (MRSA), Candida albicans, Pseudomonas aeruginosa.

In some embodiments, the NiFe₂O₄ nanoparticles have a concentration of 0.5 mg/mL of the biofilm during contacting the NiFe₂O₄ nanoparticles with the biofilm, and the NiFe₂O₄ nanoparticles reduce an amount of a Candida albicans biofilm by at least 50%, 24 h after contacting the NiFe₂O₄ nanoparticles with the biofilm.

In some embodiments, the NiFe₂O₄ nanoparticles have a concentration of 0.5 mg/mL of the biofilm contacting the NiFe₂O₄ nanoparticles with the biofilm, and the NiFe₂O₄ nanoparticles reduce an amount of a Pseudomonas aeruginosa biofilm by at least 50%, 24 h after contacting the NiFe₂O₄ nanoparticles with the biofilm.

In some embodiments, the NiFe₂O₄ nanoparticles have a concentration of 0.5 mg/mL of the biofilm during contacting the NiFe₂O₄ nanoparticles with the biofilm, and the NiFe₂O₄ nanoparticles reduce an amount of a MRSA biofilm by at least 70%, 24 h after contacting the NiFe₂O₄ nanoparticles with the biofilm.

In some embodiments, the surface is in a hospital.

In some embodiments, the NiFe₂O₄ nanoparticles attach to a cell surface and at least partially penetrate and distort a membrane of the cell in the biofilm leading to cell death.

In some embodiments, the aforementioned method further includes functionalizing a surface of the NiFe₂O₄ nanoparticles with an antibacterial compound prior to contacting the NiFe₂O₄ nanoparticles with the biofilm, where the antibacterial compound is covalently bound to the surface of the NiFe₂O₄ nanoparticles.

In some embodiments, the aforementioned method further includes functionalizing a surface of the NiFe₂O₄ nanoparticles with a photosensitizer prior to contacting and irradiating the NiFe₂O₄ nanoparticles with a photosensitizer after contacting the NiFe₂O₄ nanoparticles with the biofilm to form reactive oxygen species. The photosensitizer is covalently bound to the surface of the NiFe₂O₄ nanoparticles.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart illustrating a method for making the bioderived ferromagnetic nickel-ferrite nanoparticles (NiFe₂O₄ NPs), according to certain embodiments.

FIG. 1B is a flowchart illustrating a method for making an Aloe vera (A. vera) extract, according to certain embodiments.

FIG. 1C is a graph depicting X-ray diffraction (XRD) pattern of NiFe₂O₄ nanoparticles (NPs) synthesized via a green synthesis route, according to certain embodiments.

FIG. 2 shows Fourier transform infrared (FTIR) spectra of A. vera extract, and green synthesized NiFe₂O₄ NPs, according to certain embodiments.

FIG. 3A is a scanning electron microscopy (SEM) image of NiFe₂O₄ NPs synthesized via the green synthesis route, according to certain embodiments.

FIG. 3B shows energy dispersive X-ray (EDX) images and elemental mapping results for NiFe₂O₄ NPs synthesized via the green synthesis route, according to certain embodiments.

FIG. 4 shows a magnetic hysteresis (M-H) hysteresis loop of NiFe₂O₄ NPs synthesized via the green synthesis route, according to certain embodiments.

FIG. 5A is a scanning electron microscopy (SEM) image depicting morphology of untreated methicillin-resistant Staphylococcus aureus (MRSA), according to certain embodiments.

FIG. 5B is a SEM image depicting morphology of MRSA treated with NiFe₂O₄ NPs, according to certain embodiments.

FIG. 5C is a SEM image depicting morphology of untreated multidrug resistant Pseudomonas aeruginosa (MDR-PA), according to certain embodiments.

FIG. 5D is a SEM image depicting morphology of MDR-PA treated with NiFe₂O₄ NPs, according to certain embodiments.

FIG. 5E is a SEM image depicting morphology of untreated Candida albicans, according to certain embodiments.

FIG. 5F is a SEM image depicting morphology of C. albicans treated with NiFe₂O₄ NPs, according to certain embodiments.

FIG. 6 shows the effect of NiFe₂O₄ NPs on the biofilm-forming abilities of various pathogens, according to certain embodiments.

FIG. 7 shows the effect of NiFe₂O₄ NPs on preformed biofilms of various pathogens, according to certain embodiments.

FIG. 8A is a SEM image depicting biofilm-forming abilities of MRSA, according to certain embodiments.

FIG. 8B is a SEM image depicting effects of NiFe₂O₄ NPs on biofilm-forming abilities of MRSA, according to certain embodiments FIG. 9A is a SEM image depicting biofilm-forming abilities of MDR-PA, according to certain embodiments.

FIG. 9B is a SEM image depicting effects of NiFe₂O₄ NPs on biofilm-forming abilities of MDR-PA, according to certain embodiments.

FIG. 10A is a SEM image depicting biofilm-forming abilities of C. albicans, according to certain embodiments.

FIG. 10B is a SEM image depicting effects of NiFe₂O₄ NPs on biofilm-forming abilities of Candida albicans, according to certain embodiments.

FIG. 11A is a micrograph depicting hyphal development of untreated C. albicans, according to certain embodiments.

FIG. 11B is a micrograph depicting the decrease hyphal development of C. albicans in presence of NiFe₂O₄ NPs at a concentration of 0.25 mg/mL, according to certain embodiments.

FIG. 11C is a micrograph depicting the decrease in hyphal development of C. albicans in presence of NiFe₂O₄ NPs at a concentration of 0.50 mg/mL, according to certain embodiments.

FIG. 11D is a micrograph depicting the decrease in hyphal development of C. albicans in presence of NiFe₂O₄ NPs at a concentration of 0.75 mg/mL, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all, embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

Where a numerical limit or range is stated herein, the endpoints are included. Also, all values and subranges within a numerical limit or range are specifically included as if explicitly written out.

Furthermore, the terms “approximately”, “approximate”, “about,” and similar terms generally refer to ranges that include the identified value within a margin of 20%, 10%, or preferably 5%, and any values therebetween.

The use of the terms “include,” “includes”, “including,” “have,” “has,” or “having” should be generally understood as open-ended and non-limiting unless specifically stated otherwise.

As used herein, “particle size” may be thought of as the length or longest dimension of a particle.

A weight percent of a component, unless specifically stated to the contrary, is based on the total weight of the formulation or composition in which the component is included. For example, if a particular element or component in a composition or article is said to have 5 wt %, it is understood that this percentage is in relation to a total compositional percentage of 100%.

As used herein, “particle size” may be thought of as the length or longest dimension of a particle.

As used herein, “nanoparticles (NPs)” are particles having a particle size of 1 nm to 500 nm within the scope of the present invention.

As used herein, “sol-gel process” refers to a chemical synthesis method for materials, including resins, where an oxide network is developed through at least polycondensation reactions of a molecular precursor in a liquid. In the present case, the molecular precursors are the silane derivatives (alkoxysilanes). The finished product of a sol-gel synthesis process can be referred to as a “sol-gel material”, a “sol-gel processed material”, a “sol-gel product,” or a “sol-gel processed product.”

As used herein, the term ‘hydroxyl group’ refers to the functional group with the chemical formula —OH and composed of one oxygen atom covalently bonded to one hydrogen atom.

As used herein, “magnetic materials” refers to materials that get impacted by external electromagnetic fields in their surroundings.

As used herein, “ferromagnetic materials” refers to materials that demonstrate a spontaneous net magnetization at an atomic level despite the absence of an external magnetic field, and the materials acquire permanent magnetism.

As used herein, “crystallites” refers to tiny (generally microscopic) crystals that are bonded together by boundaries that are substantially irregular, including polycrystalline solids.

As used herein, the term “biofilm” refers to a population of microorganisms that are concentrated at an interface (usually solid/liquid) and typically surrounded by an extracellular polymeric slime matrix. Biofilms may form on living or non-living surfaces and are found in natural, industrial, and hospital settings. Biofilms can contain many different types of microorganisms, e.g., bacteria, archaea, protozoa, fungi, and algae. Preferably, such biofilms comprise bacteria, microalgae (such as Prototheca spp.), or fungi.

As used herein, the term “minimum inhibitory concentration (MIC)” is the lowest concentration of an antimicrobial (like an antifungal, antibiotic or bacteriostatic) drug that will inhibit the visible growth of a microorganism after overnight incubation.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of naturally occurring nickel ²⁸Ni include ⁵⁸Ni, ⁶⁰Ni, ⁶¹Ni, ⁶²Ni, and ⁶⁴Ni. Isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed to develop a cost-effective, non-toxic, eco-friendly, and simple approach for the green synthesis of NiFe₂O₄ nanoparticles (NPs) using aloe vera (A. vera) leaf extract by the sol-gel auto-combustion method. The synthesized NPs were effective in inhibiting the growth of drug-resistant bacteria, Candida, and their preformed biofilms.

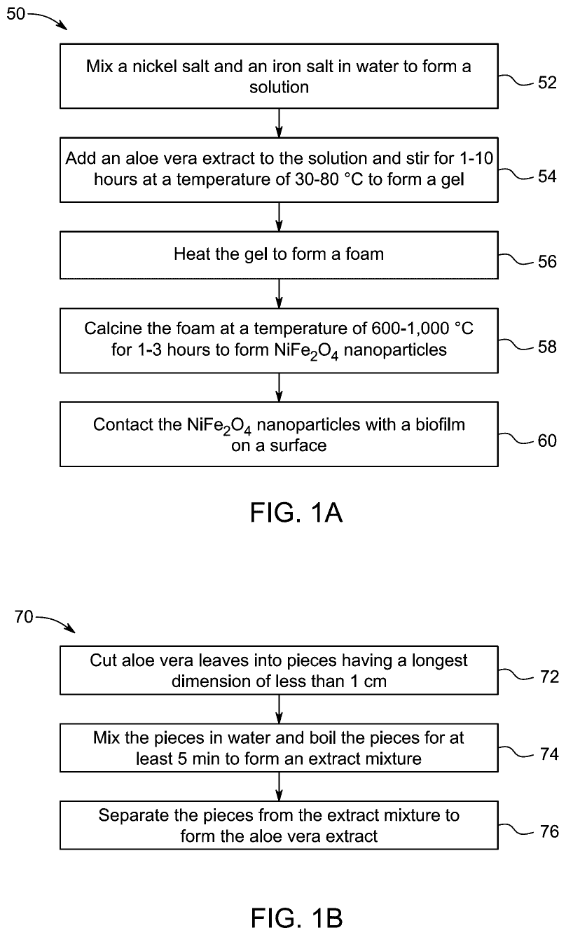

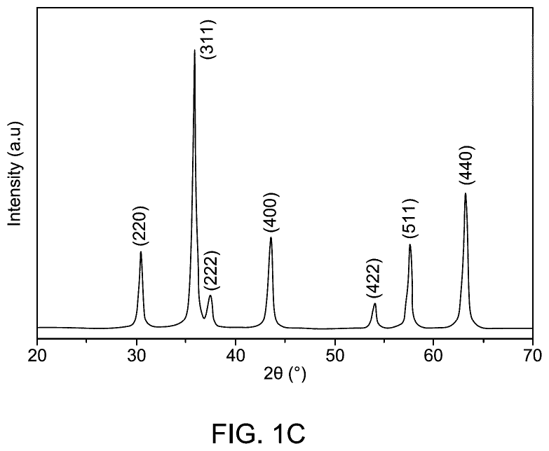

FIG. 1A illustrates a flow chart of a method 50 of a method of making and using the bioderived ferromagnetic NiFe₂O₄ NPs. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing a nickel salt and an iron salt in water to form a solution. Suitable examples of nickel salt include nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate or mixtures thereof. In a preferred embodiment, the nickel salt is nickel nitrate hexahydrate Ni(NO₃)₂·6H₂O.

Suitable examples of iron salts include iron bromide, iron chloride, iron phosphate hydrate, iron phosphate tetrahydrate, iron chloride hydrate, iron chloride tetrahydrate, iron fluoride, ammonium iron sulfate hexahydrate, iron citrate tribasic monohydrate, iron gluconate dehydrate, iron pyrophosphate, iron phthalocyanine, iron phthalocyanine chloride, ammonium iron citrate, ammonium iron sulfate, ammonium iron sulfate, ammonium iron sulfate dodecahydrate, iron chloride, iron bromide, iron chloride hexahydrate, ferric citrate, iron fluoride, iron nitrate nonahydrate, iron oxide, iron phosphate, iron sulfate hydrate, iron gluconate hydrate, iron iodide, iron lactate hydrate, iron oxalate dehydrate, ferrous sulfate heptahydrate, iron sulfide, iron acetate, iron fluoride tetrahydrate, iron iodide tetrahydrate, iron perchlorate hydrate, iron acetylacetonate, iron acetylacetonate, and iron ascorbate or its hydrate, or mixtures thereof. In a preferred embodiment, the iron salt is iron(III) nitrate nonahydrate Fe(NO₃)₃·6(H₂O)₉.

In some embodiments, the mixture includes a ratio of the nickel salt to iron salt in a range of 1:1-1:6, preferably 1:2-1:5, and preferably 1:3-1:4. In a preferred embodiment, the mixture includes a ratio of the nickel salt to iron salt of 1:2. The water may be tap water, distilled water, bi-distilled water, deionized water, deionized distilled water, reverse osmosis water, and/or some other water. In a preferred embodiment, the water is double-distilled water. The mixing may be carried out manually or with the help of a stirrer.

At step 54, the method 50 includes adding an A. vera extract to the solution and stirring for 1-10 hours (h), preferably 2-9 h, preferably 3-8 h, preferably 4-7 h, and preferably 5-6 h at a temperature of 30-80 degrees Celsius (° C.), preferably 35-75° C., preferably 40-70° C., preferably 45-65° C., and preferably 50-60° C. to form a gel. In a preferred embodiment, the method includes adding an A. vera extract to the solution and stirring for 4 h at a temperature of 50° C. to form the gel. In an embodiment, a color change occurs to form a dark colored gel. In some embodiments, the pH of the solution is adjusted to be 9-11, preferably 10, with any base known in the art such as but not limited to NaOH, or KOH.

FIG. 1B illustrates a flow chart of a method 70 of making an A. vera extract. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes cutting A. vera leaves into pieces having a longest dimension of less than 1 cm, preferably 0.5 cm, and preferably 0.1 cm. A. vera (Aloe barbadensis miller) is an important plant in Ayurveda and has been used as medicine for centuries. The leaves of the plant have shown potent anticancer, antioxidant, antidiabetic and antihyperlipidemic activities. The leaves have also been used against infections caused due to burns or wounds. It contains a variety of phytochemicals, including polysaccharides, phenolic compounds, organic acids, alkaloids, tannins, flavonoids, vitamins, enzymes, carbohydrates, and plant steroids. A. vera includes two types of aloin, A and B, which produce picric and oxalic acids of nitric acid and act as biological capping and reducing agents. These compounds promote the development of NPs and alter their surface properties. Furthermore, these metabolites and bioactive compounds can effectively capture the metal ions by serving as capping agents, reducing agents, or stabilizing agents since they are non-toxic and environmentally friendly.

At step 74, the method 70 includes mixing the pieces in water and boiling the pieces for at least 5 minutes (min), preferably 10 min, preferably 15 min, and preferably 20 min, to form an extract mixture. The water may be tap water, distilled water, bi-distilled water, deionized water, deionized distilled water, reverse osmosis water, and/or some other water. In a preferred embodiment, the water is double-distilled water. The mixing may be carried out manually or with the help of a stirrer. In a preferred embodiment, the method 70 includes mixing the pieces in water and boiling the pieces for 15 min at 80° C.

At step 76, method 70 includes separating the pieces from the extract mixture to form the A. vera extract. Suitable separation techniques include centrifugation, internal and external filtration, natural and forced sedimentation, magnetic separation, vacuum filtration, vacuum distillation, and chemical conversion. In a preferred embodiment, the separation was done using centrifugation at 10,000 rpm for 20 min, and the filtrate was then again filtered through the Whatman No. 1 filter paper.

At step 56, the method 50 includes heating the gel from step 54 to form a foam. Heating appliances such as hot plates, muffle furnaces, heating mantles ovens, microwaves, autoclaves, tapes, oil baths, salt baths, sand baths, air baths, hot-tube furnaces, and hot-air guns can be used. In a preferred embodiment, the heating is to a temperature of 30-80° C., preferably 35-75° C., preferably 40-70° C., preferably 45-65° C., and preferably 50-60° C. In some embodiments, the foam has a density of 0.1-5 kg/m³, preferably 0.1-5 kg/m³, 0.2-4 kg/m³, 0.5-3 kg/m³, 0.7-2 kg/m³, or about 1 kg/m³. In some embodiments, the foam has a water content of less than 10 wt. % based on a total weight of the foam, preferably less than 8 wt. %, 6 wt. %, 4 wt. %, 2 wt. %, 1 wt. %, or 0.1 wt. %.

At step 58, the method 50 includes calcining the foam at a temperature of 600-1000° C., preferably 620-980° C., preferably 640-960° C., preferably 660-940° C., preferably 680-920° C., preferably 700-900° C., preferably 720-880° C., preferably 740-860° C., preferably 760-840° C., and preferably 780-820° C. for 1-3 h, preferably 1.5-2.5 h, and preferably 1.75-2.25 h to form NiFe₂O₄ NPs. The calcination of the foam is carried out by heating it to a high temperature under a restricted supply of ambient oxygen. This is performed to remove impurities or volatile substances and to incur thermal decomposition. Typically, the calcination is carried out in a furnace, preferably equipped with a temperature control system, which may provide a heating rate of up to 50° C./min, preferably up to 40° C./min, preferably up to 30° C./min, preferably up to 20° C./min, preferably up to 10° C./min, preferably up to 5° C./min, preferably up to 2° C./min, and preferably up to 1° C./min. In some embodiments, the NiFe₂O₄ nanoparticles include phenolic compounds on a surface. In some embodiments, the phenolic compounds are selected from the group consisting of flavonoids, phenolic acids, tannins, stilbenes, and lignans. The calcining removes phenolic compounds from the surface of the NiFe₂O₄ NPs. In some embodiments, the surface of the NiFe₂O₄ nanoparticles has negatively charged hydroxyl groups.

In some embodiments, the NiFe₂O₄ NPs are crystalline. The NiFe₂O₄ NPs have a spinel structure. Spinel oxides having AB₂O₄ (A=Mn, Cu, Ni, Zn, Fe, Ni; B=Cr, Ni, Mn, Mo, Ni) formula have normal, inverse, or complex structures determined by cation occupation of octahedral (Oh) or tetrahedral (Td) sites. In a preferred embodiment, the NiFe₂O₄ NPs have an inverse spinel structure or a spinel structure.

In some embodiments, the NiFe₂O₄ NPs may exist in various morphological shapes, such as nanowires, nanospheres, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc., and mixtures thereof. In a preferred embodiment, the NiFe₂O₄ NPs have a spherical shape. In some embodiments, the NiFe₂O₄ NPs have an irregular shape.

In some embodiments, the NiFe₂O₄ NPs have an average size of 10-40 nm, preferably 11-39 nm, preferably 12-38 nm, preferably 13-37 nm, preferably 14-36 nm, preferably 15-35 nm, preferably 16-34 nm, preferably 17-33 nm, preferably 18-32 nm, preferably 19-31 nm, preferably 20-30 nm, preferably 21-29 nm, preferably 22-28 nm, preferably 23-27 nm, and preferably 24-26 nm. In some embodiments, the NiFe₂O₄ NPs form aggregates having an average size of 1-3 μm, preferably 1.5-2.5 μm, and preferably 1.75-2.25 μm.

In some embodiments, the NiFe₂O₄ NPs include 15-25 wt. % 0, preferably 16-24 wt. %, preferably 17-23 wt. %, preferably 18-22 wt. %, and preferably 19-21 wt. % of 0, 45-55 wt. % Fe, preferably 46-54 wt. %, preferably 47-53 wt. %, preferably 48-52 wt. %, and preferably 49-51 wt. % of Fe and 30-40 wt. % Ni, preferably 31-34 wt. %, and preferably 32-33 wt. % of Ni based on a total weight of the NiFe₂O₄ NPs. In a preferred embodiment, the NiFe₂O₄ NPs include 19.68 wt. % 0, 48.32 wt. % of Fe, and 32 wt. % of Ni based on the total weight of the NiFe₂O₄ NPs.

In some embodiments, the NiFe₂O₄ NPs have a saturation magnetization of 40-50 electromagnetic units per gram (emu/g), preferably 26-34 emu/g, preferably 27-33 emu/g, preferably 28-32 emu/g, and preferably 29-31 emu/g at 300 K. In a preferred embodiment, the NiFe₂O₄ NPs have a saturation magnetization of 29.87 emu/g at 300 K.

At step 60, the method 50 includes contacting the NiFe₂O₄ NPs with a biofilm on a surface. In some embodiments, the biofilm is formed by at least one of Methicillin-resistant Staphylococcus aureus (MRSA), Candida albicans, Pseudomonas aeruginosa, Staphylococcus aureus, Escherichia coli, multidrug-resistant Pseudomonas aeruginosa (MDR-PA), and Candida parapsilosis. In some embodiments, the biofilm is formed by at least one of methicillin-resistant Staphylococcus aureus (MRSA), Candida albicans, and Pseudomonas aeruginosa. The biofilms are formed on various surfaces, for example, the surface of a hospital or a healthcare facility, as well as plumbing systems (e.g., sink drain), countertops, building materials, ductwork, and clean rooms. The surface also refers to the interior or exterior of pipes, for example, drains, as well as swimming pools, tanks (e.g., for aquaculture), purification filters, toilet bowls, sinks, and surfaces in the greenhouse.

In some embodiments, the surface is of a medical device, such as prosthetics (hip implants, dental implants, prosthetic joint, a voice prosthetic, a penile prosthetic) a mechanical heart valve, a cardiac pacemaker, an arteriovenous shunt, a schleral buckle, catheters (e.g., central venous catheter, an intravascular catheter, a urinary catheter, a Hickman catheter, a peritoneal dialysis catheter, an endrotracheal catheter), tympanostomy tube, a tracheostomy tube, a surgical suture, a bone anchor, a bone screw, an intraocular lens, a contact lens, an intrauterine device, an aortofemoral graft, or a vascular graft. Other infections from medical devices include those from abdominal drains, biliary tract stents, breast implants, cardiac pacemakers, cerebrospinal fluid shunts, contact lenses, defibrillators, dentures, electrical dialyzers, endotracheal tubes, indwelling urinary catheters, intrauterine devices, intravenous catheters, joint prostheses, mechanical heart valves, nephrostomy tubes, orthopedic implants, peritoneal dialysis catheters, prosthetic heart valves, prosthetic joints allosplastic orthopedic devices, tissue fillers, urethral stents, vascular prostheses, ventilator-associated pneumonia, ventricular assist devices, ventricular derivations, ventricular shunts, and voice prostheses. In some embodiments, the surface is of a surgical device, such as a clamp, forceps, scissor, skin hook, tubing, needle, retractor, scaler, drill, chisel, rasp, or saw.

In some embodiments, the NiFe₂O₄ NPs have a concentration of 0.125-1 milligrams per milliliter (mg/mL), 0.150-0.750 mg/mL, 0.175-0.5 mg/mL, 0.2-0.25 mg/mL of the biofilm while contacting the NiFe₂O₄ NPs with the biofilm. The NiFe₂O₄ NPs reduce the amount of the biofilm after contact. In some embodiments, the NiFe₂O₄ NPs have a minimum inhibitory concentration (MIC) of 1.6-2 mg/mL and preferably 1.7-1.9 mg/mL of the biofilm after contacting the NiFe₂O₄ NPs with the biofilm. The NiFe₂O₄ NPs attach to a cell surface and at least partially penetrate and distort a cell membrane in the biofilm, leading to cell death.

In some embodiments, the NiFe₂O₄ NPs have a concentration of 0.5 mg/mL of the biofilm while contacting the NiFe₂O₄ NPs with the biofilm. The NiFe₂O₄ NPs reduce the amount of a Candida albicans biofilm by at least 50%, preferably 55%, preferably 60%, preferably 65%, preferably 70%, 24 h after contacting the Candida albicans biofilm with the NiFe₂O₄ NPs. The NiFe₂O₄ NPs reduce the amount of a Pseudomonas aeruginosa biofilm by at least 50%, preferably 55%, preferably 60%, preferably 65%, preferably 70%, 24 h after contacting the Pseudomonas aeruginosa biofilm with the NiFe₂O₄ NPs. The NiFe₂O₄ NPs reduce the amount of a MRSA biofilm by at least 70%, preferably 75%, preferably 80%, and preferably 85%, 24 h after contacting the MRSA biofilm with the NiFe₂O₄ NPs.

In an embodiment, the method 50 further includes functionalizing the surface of the NiFe₂O₄ NPs with an antibacterial compound prior to contacting the NiFe₂O₄ NPs with the biofilm. The functionalization allows the penetration of the antibacterial agents into the polysaccharide matrix of the bacterial cells. The antibacterial is bound to the surface of the NiFe₂O₄ NPs. The nature of bonding between the antibacterial compound and the NiFe₂O₄ NPs may be covalent or non-covalent; however, in preferred embodiments, the antibacterial compound is covalently bound to the NiFe₂O₄ NPs. In some embodiments, the antibacterial compound is covalently bound through the hydroxyl groups on the surface of the NPs, thereby creating a bond as follows, NP—O-Antibacterial. In a preferred embodiment, the antibacterial compound is selected from the group consisting of amoxicillin, doxycycline, cephalexin, ciprofloxacin, clindamycin, metronidazole, azithromycin, sulfamethoxazole, trimethoprim, clavulanate, levofloxacin.

In yet another embodiment, the method 50 further includes functionalizing a surface of the NiFe₂O₄ NPs with a photosensitizer prior to contacting the NiFe₂O₄ NPs with the biofilm. Photosensitizers are light absorbers that change the course of a photochemical reaction. Photosensitizers utilize light to enact a chemical change in another species, after the chemical change, the photosensitizer returns to its initial state, remaining chemically unchanged from the process. For example, upon absorption of light a photosensitizer can induce the formation of reactive oxygen species (ROS) from ambient oxygen. ROS include, but are not limited to, superoxide anion radical, hydroxyl radical, hydroperoxyl radical, and singlet oxygen. The production of various types of ROS causes the penetration of NPs inside the cell that may interfere with cell wall synthesis; penetration of NPs causes the rupturing of the cytoplasmic membrane that leads to the leakage of genetic materials, proteins, and minerals that cause the death of bacteria. In some embodiments, the photosensitizer is covalently bound to the surface of the NiFe₂O₄ NPs. In some embodiments, the photosensitizer is covalently bound through the hydroxyl groups on the surface of the NPs, thereby creating a bond as follows, NP—O-Photosensitizer. In some embodiments, the photosensitizer is selected from the group consisting of methylene blue, toluidine blue, curcumin, hypericin, phthalocyanines, and porphyrins. In some embodiments, the method includes irradiating the NiFe₂O₄ NPs with the photosensitizer after contacting with the biofilm to form reactive oxygen species. The irradiating is with any light source having a wavelength of 300-800 nm, preferably 350-750 nm, 400-700 nm, 450-650 nm, or 500-550 nm.

### EXAMPLES

The following examples demonstrate a method of fabrication of NiFe₂O₄ nanoparticles (NPs) using Aloe vera leaf extract and using the NPs to reduce biofilm growth. The examples are provided solely for illustration and are not to be construed as limitations of the present disclosure, as many variations thereof are possible without departing from the spirit and scope of the present disclosure.

### Example 1: Materials

Nickel nitrate hexahydrate Ni(NO₃)₂·6(H₂O) and ferric nitrate nonahydrate Fe(NO₃)₃·9(H₂O) were purchased from Sigma Aldrich, USA, as starting materials. Aloe vera was obtained from a local garden. Brain heart infusion (BHI), RPMI 1640, Mueller Hinton agar, Sabouraud dextrose agar, glutaraldehyde, osmium tetroxide, paraformaldehyde, trypticase soy broth (TSB), glucose, ethanol, 3-(4,5-dimethylthiazol-2-yl)-2,5-diphenyltetrazolium bromide (MTT) assay kit, Dulbecco's modified Eagle medium (DMEM) penicillin-streptomycin (1%), L-glutamine, fetal bovine serum (FBS), 4′,6-diamidino-2-phenylindole (DAPI), phosphate-buffered saline (PBS), and Triton X-100 were purchased from Molequle-ON, New Zealand. All reagents were used without further purification.

### Example 2: Preparation of the Aloe vera Leaf Extract

Aloe vera (A. vera) plants were chosen for the biosynthesis of NiFe₂O₄ NPs due to their accessibility, affordability, and medicinal benefits. Fresh A. vera leaves were cleaned in double-distilled water to eliminate dust. The leaves were then cut into small pieces and dried in the air. In 500 milliliters (mL) beakers with 200 mL of distilled water, 20 g of finely chopped leaves were added and boiled for 15 minutes (min) at 80 degrees Celsius (° C.). After cooling to 37° C., these leaves were centrifuged at 10,000 revolutions per minute (rpm) for 20 minutes at 4° C., and the supernatant fluid was then filtered through Whatman No. 1 filter paper. The collected supernatant (solution A) was kept at 4° C. to 8° C. and used as a capping agent in the biosynthetic pathways of NiFe₂O₄ NPs.

### Example 3: NiFe₂O₄ NP Synthesis

A green sol-gel process, followed by auto-combustion, was used to synthesize NiFe₂O₄ nanopowder. Nickel nitrate and iron nitrate in 1:2 ratios were mixed in 50 mL of double-distilled water and centrifuged to get a clear solution (solution B). 50 mL aqueous A. vera extract of solution A was transferred to solution B to obtain a mixture. The mixture was vigorously stirred at 50° C. for 4 hours (h), the resulting sol began to transform into a brown, viscous gel, signifying the completion of the reduction process. The pH was adjusted to 10 using a sodium hydroxide (NaOH) solution. A dark precipitate started to form after being cooled to 37° C. overnight, indicating the beginning of the formation of NPs. The NPs were separated using centrifugation for 15 min at 4° C. and an rpm of 12,000. Further, to remove any remaining biological molecules, they were washed with deionized water five times, followed by a single washing with 100% ethanol. A fine powder was formed after the purified NPs were dried in a hot air oven at 60° C. The gels initially melted and then spontaneously self-ignited, releasing magnetic foams as a byproduct. The magnetic foams were then calcined at 800° C. for 2 h to increase crystallization. Additionally, the particles were treated with ultrasound to disperse the individual particles.

### Example 4: Characterization Techniques

X-ray diffraction (XRD) analysis was used to analyze the phase composition, crystal structure, and size of the NPs using CuKα radiation (λ=1.54056) in the range of 20°<20<800 at 40 kilo electron volts (keV) using an X-ray powder diffractometer (Shimadzu XRD-7,000). A Fourier transform infrared (FTIR) spectrometer (Shimadzu IRSpirit, Shimadzu, Japan) was used to determine the functional group present in A. vera extract and the synthesized NPs in the range of 4000 cm⁻¹ to 500 cm⁻¹. Scanning electron microscopy (SEM) (TESCAN VEGA3) and transmission electron microscopy (TEM) (Morgagni 268) were used to further analyze the size and shape of the synthesized NPs. Furthermore, the elemental composition of NPs was carried out using energy dispersive X-ray (EDX) (TESCAN VEGA3). The hydrodynamic diameter and surface charge (zeta potential) were measured using a DLS and Nano-ZS Zetasizer (Malvern Instruments, UK). The electron binding energies for the elements were measured by X-ray photoelectron spectroscopy (XPS) on an ESCALAB 250Xi X-ray photoelectron spectrometer. VSM (7410; USA) was used to create a magnetic field characteristic at 37 degrees Celsius (° C.) with a maximum external magnetic field of 10,000 Oe.

### Example 5: Antimicrobial Activity

A two-fold microbroth dilution method was used to determine the minimum inhibitory concentration (MIC) of NiFe₂O₄ NPs. The bacteria methicillin-resistant Staphylococcus aureus (MRSA), multi-drug-resistant Pseudomonas aeruginosa (MDR-PA), and C. albicans cultures treated with two-fold serial dilutions of NiFe₂O₄ (0.156 mg/dl to 10 mg/mL) were incubated at 37° C. for 24 h. The MIC value is defined as the lowest concentration of NPs at which no visible growth was observed.

### Example 6: Effect of NiFe₂O₄ NPs on Pathogen Morphology as Visualized by SEM

SEM has been performed to visualize the morphological changes caused by NPs in bacteria and Candida after treatment with NiFe₂O₄ NPs by adopting the following protocol. The impact of NiFe₂O₄ NPs on the architecture of the tested biofilm strains was further examined by SEM. In a 12-well culture plate, 100 microliters (μl) of fresh cultures of bacteria and Candida cells were grown on the coverslip for 24 hours (h) at 37° C. and 28° C., respectively. The coverslips were removed after the incubation, washed with PBS to get rid of the un-adherent cells, and then fixed with glutaraldehyde (2.5% v/v). Moreover, the coverslips were rinsed again in PBS and dehydrated with a series of ethanol concentrations, including 20%, 30%, 40%, 50%, 60%, 70%, 80%, and 90%, one time for each, and twice in 100% for 10 min each, and then air-dried. Finally, SEM images of Candida and bacterial biofilm structures were taken at 20 kilovolts (kV).

### Example 7: Effect of NiFe₂O₄ NPs on Biofilm-Forming Capabilities of Bacteria and Candida

The biofilm prevention of bacteria and Candida after treatment with NiFe₂O₄ NPs was examined by crystal violet bioassay. The freshly harvested cultures were inoculated in a 96-well plate containing TSB+2% glucose in the case of bacteria and RPMI+2% glucose in the case of Candida, and then, each plate was incubated for 24 h at 37° C. and 28° C., respectively, after being exposed to various NiFe₂O₄ NP concentrations. The NiFe₂O₄ NP-free bacteria and Candida were used as controls. All of the contents were removed from the wells after the incubation time and delicately washed three times with PBS, and further, the microtiter plate was left for air drying. Crystal violet (0.1% w/v) was used to stain the adhered biofilms for 30 min, and then, the dyes were decanted, cleaned with PBS, and allowed to dry. The stained biofilm was hydrolyzed with 95% ethanol after the wells were dried, and the absorption spectrum was recorded at 595 nanometers (nm).

### Example 8: Eradication of the Established Biofilms by NiFe₂O NPs

Additionally, the impact of NiFe₂O₄ NPs on preformed bacterial and Candida biofilms, inoculated in TSB+2% glucose and RPMI+2% glucose, respectively, was investigated. In this assay, the test cultures were incubated for 24 h without any intervention, resulting in the formation of biofilms in 96-well polystyrene plates. To remove the weakly adhered and planktonic bacteria, a gentle rinsing with PBS was applied to the wells. Furthermore, fresh RPMI was once again poured into the wells, and NiFe₂O₄ NPs were then added to achieve the required concentrations. Another 24 hours of static incubation was done on the microtiter plate. As aforementioned, biofilms were stained, and the wells of polystyrene plates were washed. Using a microplate reader, the optical density (OD) of the wells was measured at 595 nm. The data is displayed as the percentage of biofilms that are still observable in treatment groups when compared to untreated control groups.

### Example 9: SEM and Light Microscopic Visualization of Biofilm Architecture

The impact of NiFe₂O₄ NPs on the architecture of the tested biofilm strains was further examined by SEM. In a 12-well culture plate, 100 microliters (μl) of fresh cultures of bacteria and Candida cells were grown on the coverslip for 24 h at 37° C. and 28° C., respectively. The coverslips were removed after the incubation, washed with PBS to get rid of the un-adherent cells, and then fixed with glutaraldehyde (2.5% v/v). Moreover, the coverslips were rinsed again in PBS and dehydrated with a series of ethanol concentrations, including 20%, 30%, 40%, 50%, 60%, 70%, 80%, and 90%, one time for each, and twice in 100% for 10 min each, and then air-dried. Finally, SEM images of Candida and bacterial biofilm structures were taken at 20 kilovolts (kV).

### Example 10: Light Microscopic Analysis of the Effect of NPs on the Hyphal Formation of C. albicans

A methodology was used to determine the impact caused by NPs on yeast-to-hyphal morphogenesis. In particular, C. albicans cultured in YPED broth supplemented with 10% FBS was incubated in a shaker incubator at 160 rpm overnight at 37° C. Different doses of NPs were added in the treatment groups, whereas no NPs were added in the control group. After incubation for four hours, yeast cells and hyphal forms have been observed and imaged using a light microscope.

### Example 11: Synthesis of NiFe₂O₄ NPs

The following illustrates how A. vera leaf extract contributes to the synthesis of NiFe₂O₄ NPs. The polyphenolic compounds (PCs) present in the extract combine with Fe³⁺ and Ni²⁺ ions to form brownish-green PCs—Fe—Ni complex. Finally, NiFe₂O₄ NPs (brown-black) were obtained after the complex was decomposed via heat treatment.

$${Ni ( {NO}_{3} )}_{2} \cdot 6 {H}_{2} O + {Fe ( {NO}_{3} )}_{3} \cdot 9 {H}_{2} O + Aloe vera extract = PCs - {NiFe}_{2} {O}_{4} + 6 {NO}_{2} + 15 {H}_{2} O$$

$$PCs - {NiFe}_{2} {O}_{4} + calcination ( 800 ° C . / 2 h ) : {NiFe}_{2} {O}_{4} nano powder .$$

### Example 12: XRD Analysis

FIG. 1C displays the XRD powder pattern of NiFe2O4 NPs synthesized via green synthesis. Table 1 shows the lattice characteristics and crystallite sizes (22.2 nm) determined using Scherrer's formula. As can be seen from FIG. 1C, the product does not have any impurity. The detected peaks correspond to the crystallographic planes (220), (311), (222), (400), (422), (511), and (440), as illustrated in FIG. 1C.

TABLE 1
Structural characteristics of NiFe₂O₄ NPs

| | a (Å) | V (Å)³ | D_{XRD} (±0.05 nm) | χ²(chi²) | R_{Bragg} |
|---|---|---|---|---|---|
| NiFe₂O₄ | 8.3365 | 579.3740 | 22.2 | 6.8 | 39 |

### Example 13: Fourier Transform Infrared (FTIR) Spectroscopy

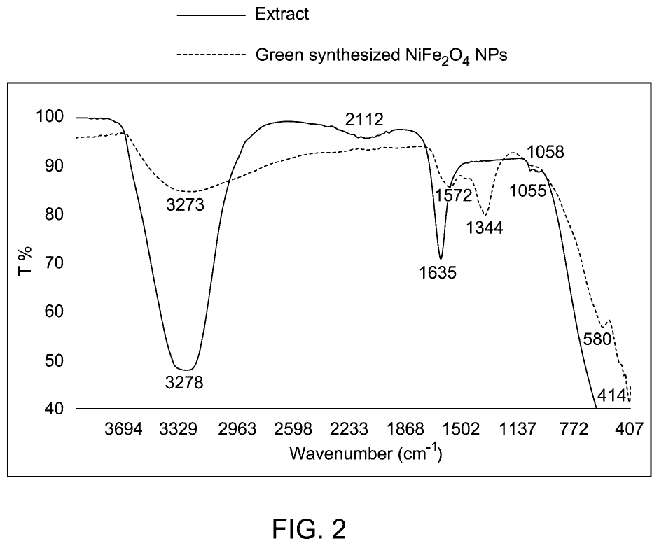

FTIR was performed in the 4000 cm⁻¹ to 400 cm⁻¹ region, as shown in FIG. 2, to determine the potential function of functional groups in plant extracts and verify the spinel structure of biosynthesized NPs. The absorption peaks observed at 580 cm⁻¹ and 414 cm⁻¹ are attributed, respectively, to stretching vibrations of the tetrahedral metal-oxygen bond and the octahedral metal-oxygen bond. These bands confirmed the formation of the spinel-structured nickel ferrite.

The peaks at 1635 cm⁻¹ and 1344 cm⁻¹ indicate the hydroxyl groups (—OH) of phenolic compounds present in plant extract. The peaks observed at 1055 cm⁻¹, 1572 cm⁻¹, and 3,278 cm⁻¹ in the aloe vera extract are attributed to the H—O—H, C—O—C, and —OH groups of polyphenolics compounds which functioned as stabilizing and reducing agents.

### Example 14: Scanning Electron Microscopy (SEM) and Energy Dispersive X-Ray (EDX) Spectroscopy

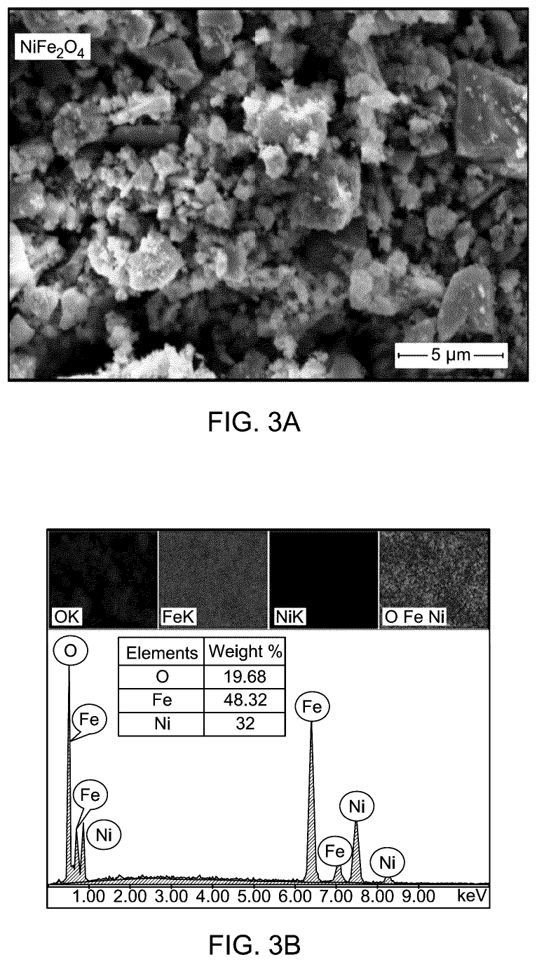

FIG. 3A revealed the SEM image of NiFe₂O₄. The image showed highly aggregated irregular roughly spherical shapes particles due to its magnetic nature and/or the residual organic compounds present in the extract. Further, elemental mapping and the EDX spectra of NiFe₂O₄ are illustrated in FIG. 3B, respectively. FIG. 3B shows the existence of Ni, Fe, and O, and no impurities.

### Example 15: Magnetic Properties (VSM)

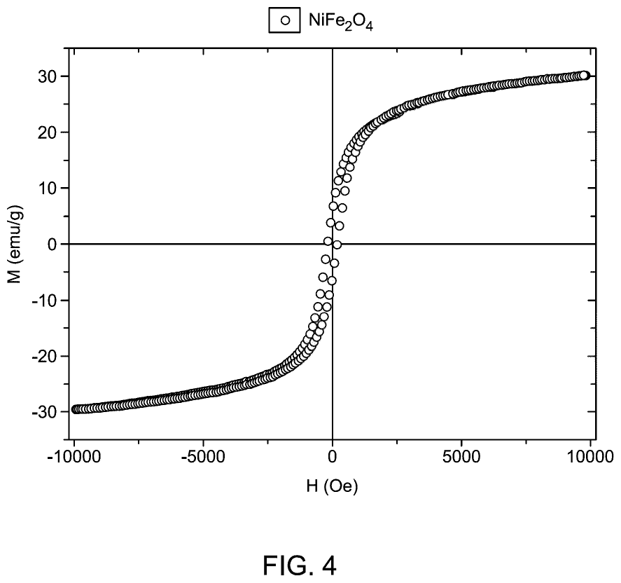

Magnetic field dependence (H) measurements of magnetizations (M) of NiFe₂O₄ NPs produced by green synthesis were made using a 7304 model Lake Shore vibrating sample magnetometer. The M-H behavior of NiFe₂O₄ NPs was measured in a magnetic field of ±1 Tesla and at 300 K, as shown in FIG. 4. As can be seen from FIG. 4, the NiFe₂O₄ NPs are soft magnetic materials from the hysteresis loop. Its saturation magnetization (Ms) value was found to be 29.87 electromagnetic units per gram (emu/g) at 300K.

### Example 16: Minimum Inhibitory Concentration Determination

Standard broth dilution procedures were employed to assess the antibacterial efficacy of NiFe₂O₄ NPs against the selected pathogens. The MIC value for bacterial isolates, including MDR-PA and MRSA, was 1.6 mg/mL, while for C. albicans, it was 2 mg/mL.

### Example 17: SEM Visualization of Effects of NPs on the Morphology of Test Pathogens

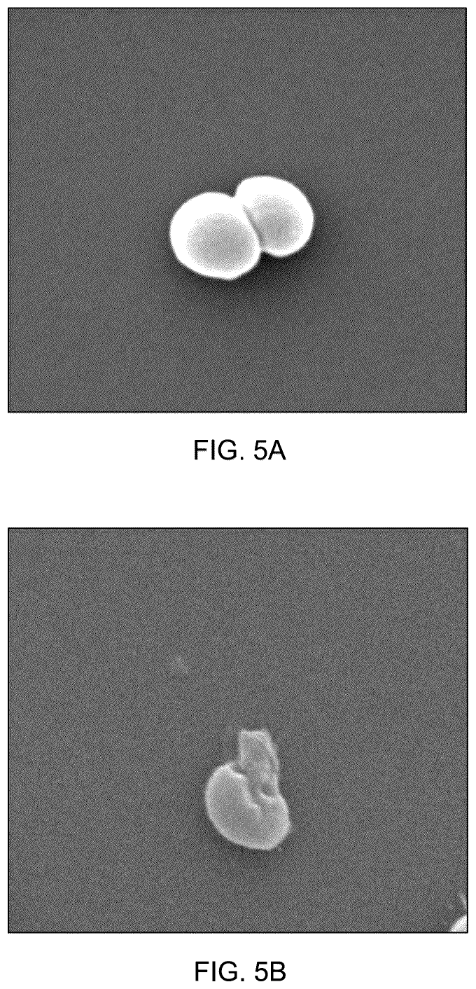

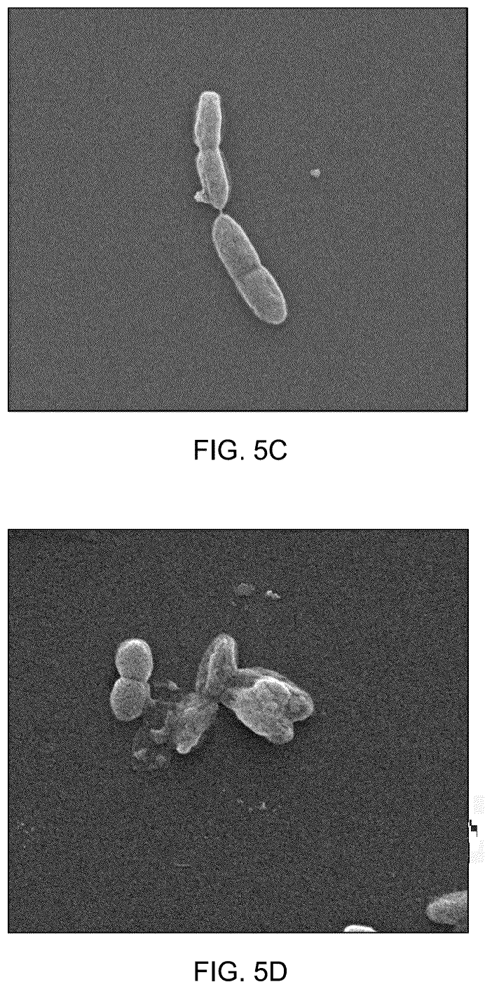

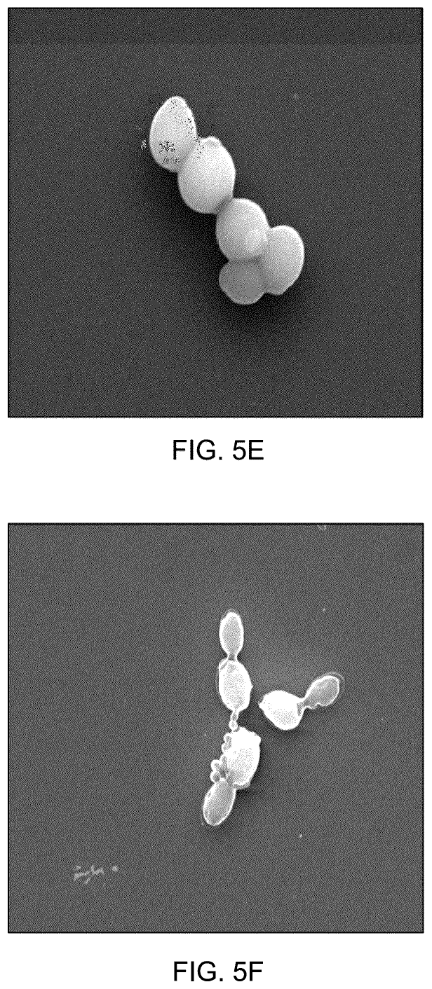

The impact of NiFe₂O₄ NPs on the morphological characteristics of test pathogens was examined through the utilization of SEM. Structural deformities can be clearly seen in cells treated with NiFe₂O₄. SEM visualization, as shown in FIGS. 5A-5F clearly shows the untreated cells of MRSA, P. aeruginosa, and C. albicans with normal morphology, whereas the cells treated with NiFe₂O₄ show structural deformities and cavities. The SEM micrograph demonstrated that the surface of bacterial and Candida cells in the control group (untreated) appeared smooth and exhibited the characteristic features of native cells, including a regular, smooth, and intact surface, as shown in FIG. 5A, FIG. 5C, and FIG. 5E. However, treated cells demonstrated structural abnormalities in MRSA, P. aeruginosa, and C. albicans, and it was observed that NiFe₂O₄ NPs severely damaged and shattered the cell wall and membrane, subsequently leading to a change in the permeability of the membrane, as shown in FIG. 5B, FIG. D, and FIG. 5F). Certain cells exhibited leakage, while others were distorted and fragmented. Membrane disintegration and pits were also visible in the SEM micrograph, as shown in FIG. 5B, FIG. 5D, and FIG. 5F.

### Example 18: Effect of NiFe₂O₄ NPs on Biofilm Formation

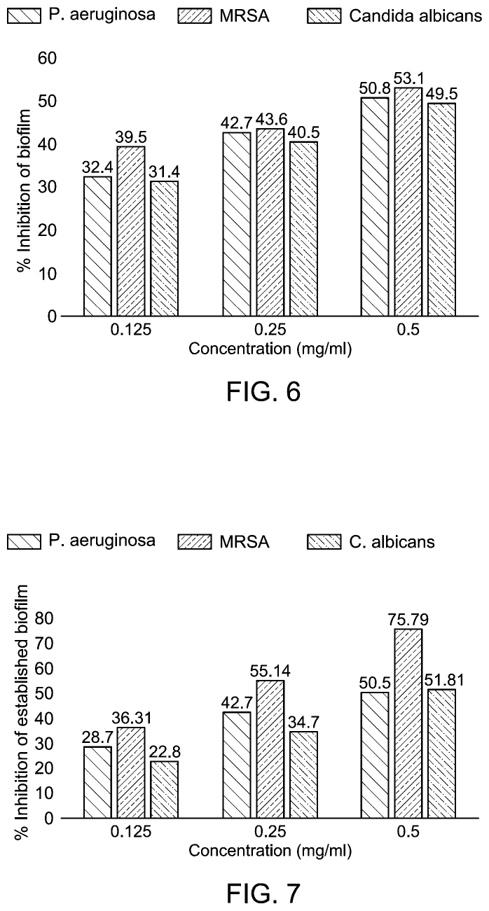

Biofilm formation was inhibited at all the tested concentrations of NiFe₂O₄ NPs, including 0.125 mg/mL, 0.25 mg/mL, and 0.5 mg/mL. Biofilm formation was inhibited by 32.4% for P. aeruginosa, 39.5% for MRSA, and 31.4% for C. albicans at 0.125 mg/mL of NiFe₂O₄ NPs. Further, a higher concentration of about 0.25 mg/mL of NiFe₂O₄ NPs inhibited the biofilm formation by 42.7% for P. aeruginosa, 43.6% for MRSA, and 40.5% for C. albicans. The highest concentration of NiFe₂O₄ NPs prevented the formation of biofilm in P. aeruginosa by 50.8%, MRSA by 53.1%, and C. albicans by 49.5%, as shown in FIG. 6. The NiFe₂O₄ NPs may affect all the microorganisms irrespective of gram-positive, gram-negative, and fungi, as shown in FIG. 6.

### Example 19: Eradication of the Established Biofilms by NiFe₂O₄ NPs

The established biofilm was also eradicated at different concentrations of NiFe₂O₄ NPs. At 0.125 mg/mL of NiFe₂O₄ NPs, the established biofilm was inhibited by 28.7% for P. aeruginosa, 36.31% % for MRSA, and 22.8% for C. albicans. The higher concentration of about 0.25 mg/mL of NiFe₂O₄ NPs inhibited the established biofilm by 42.7% for P. aeruginosa, 55.14% for MRSA, and 34.7% for C. albicans. The highest concentration of NiFe₂O₄ NPs eliminates biofilm by 50.5% for P. aeruginosa, 75.791% for MRSA, and 51.81% for C. albicans, as shown in FIG. 7.

### Example 20: Biofilm Architecture Visualization Using SEM

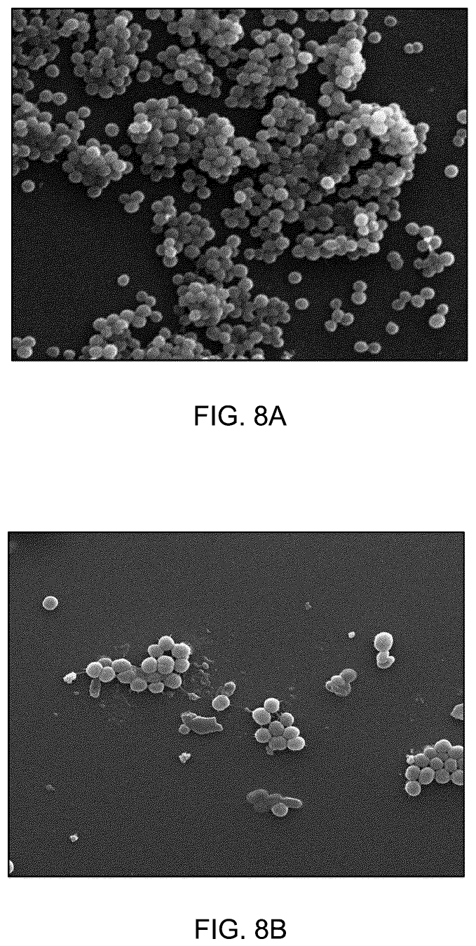

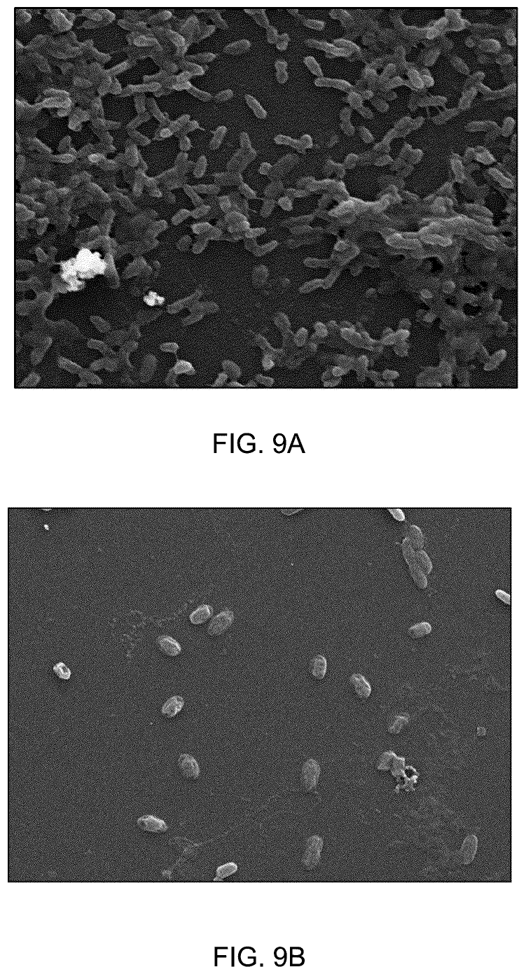

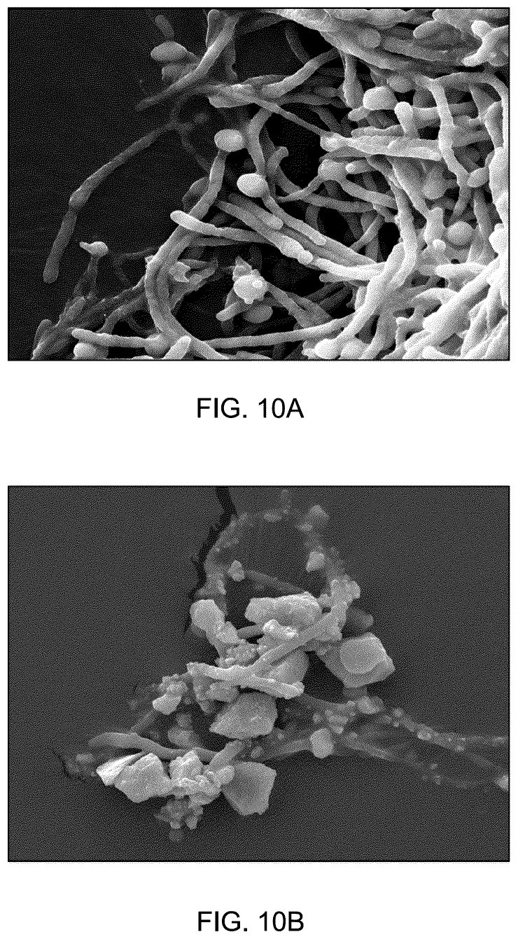

SEM examination was also utilized to look into the impact of NPs on the biofilms of MRSA, C. albicans, and MDR-PA that had grown on the glass surface. The control/untreated images of MRSA are provided in FIG. 8A, P. aeruginosa are provided in FIG. 9A, and C. albicans are provided in FIG. 10A. The aforementioned images show a greater number of cells attached to the surface, whereas, after NiFe₂O₄ NPs treatment, a decrease in the number of biofilm-forming cells in MRSA, P. aeruginosa, and C. albicans has been observed, as shown in FIG. 8B, FIG. 9B, and FIG. 10B, respectively. SEM examination revealed that cells exposed to NPs impede their ability to adhere to the surface, which is needed for the development of biofilms.

Referring to FIG. 8A and FIG. 9A, the untreated glass coverslips facilitate the attachment, development, and aggregation of a number of MRSA and MDR-PA cells. However, the treatment of NiFe₂O₄ NPs to MRSA and MDR-PA biofilm resulted in a notable decrease in cell adhesion and colonization. Additionally, referring to FIG. 8B and FIG. 9B, the biofilm architecture was severely disrupted, as evidenced by the presence of scattered cells with damaged cell walls and membranes. This indicates that the NPs caused damage to the biofilm structure and extracellular polymeric substance (EPS) matrix.

C. albicans biofilms include yeast, hyphal, and pseudo-hyphal components, and the mechanism of yeast cells transforming into hyphae is thought to regulate the development of biofilms. Predominantly large and dense networks of hyphal and densely clustered cells were seen in the untreated-control biofilm of Candida, as shown in FIG. 10A. A reduction in biofilm and hyphae development, primarily including a few scattered cells, was observed following NiFe₂O₄ NPs treatment, as shown in FIG. 10B. Moreover, a decrease in the number of cells and the absence of true hyphae were observed after treatment with NPs, further depicted in FIG. 10B. NiFe₂O₄ was found to potently limit hypha formation and cell aggregation, as well as to drastically reduce the growth of C. albicans biofilms, as shown in FIG. 10B.

### Example 21: Light Microscopic Observation of the Effect of NiFe₂O₄ on the Hyphal Formation of C. albicans

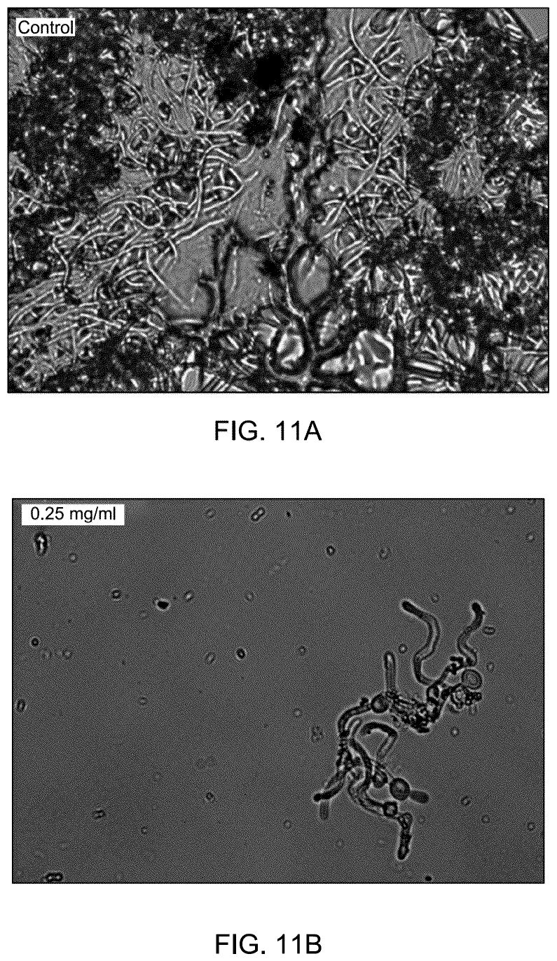

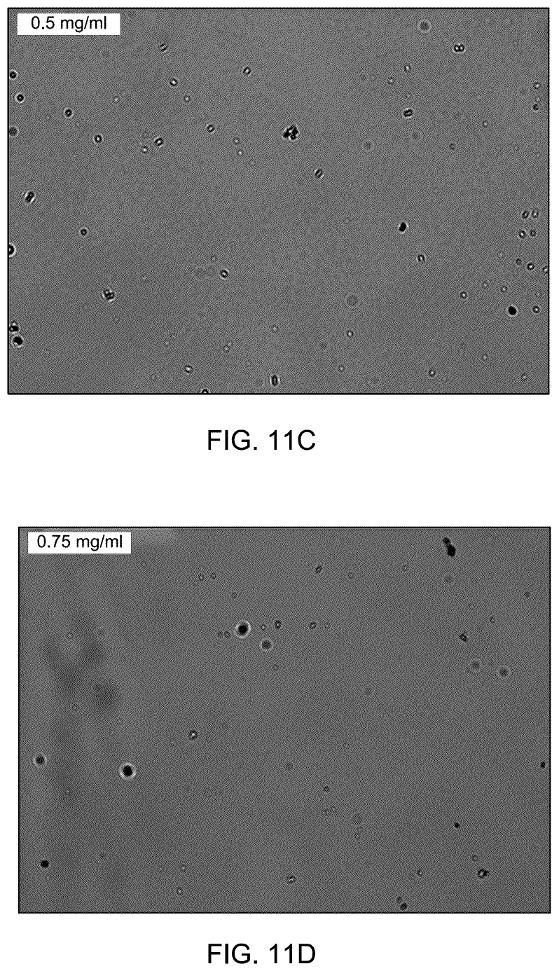

Furthermore, a microscopic observation of the yeast-to-hyphal transition was performed in C. albicans after treatment with NiFe₂O₄ NPs is shown in FIGS. 11A-11D. NiFe₂O₄ decreases the biofilm formations by interfering with the hyphal formation and as the dose of NPs increases from 0.25 mg/mL to 0.75 mg/mL, the hyphal formation decreases, as shown in FIGS. 11A-11D. The NiFe₂O₄ NPs-treated C. albicans culture showed scattered yeast cells with fewer aggregates than the control, which had a heavily interwoven hyphal network with intruding yeast cell clumps.

Numerous modifications and variations of the present disclosure are possible in light of the above teachings. It is therefore to be understood that within the scope of the appended claims, the invention may be practiced otherwise than as specifically described herein.

1. A method of reducing a biofilm, comprising:
mixing a nickel salt and an iron salt in water to form a solution;
adding an aloe vera extract to the solution and stirring for 1-10 h at a temperature of 30-80° C. to form a gel;
heating the gel to form a foam;
calcining the foam at a temperature of 600-1,000° C. for 1-3 h to form NiFe₂O₄ nanoparticles, and
contacting the NiFe₂O₄ nanoparticles with a biofilm on a surface,
wherein the NiFe₂O₄ nanoparticles reduce an amount of the biofilm after the contacting,
wherein the NiFe₂O₄ nanoparticles have an average size of 10-40 nm, and
wherein the NiFe₂O₄ nanoparticles form aggregates having an average size of 1-3 μm.

2. The method of claim 1, wherein the NiFe₂O₄ nanoparticles are crystalline.

3. The method of claim 1, wherein the NiFe₂O₄ nanoparticles have a spinel structure.

4. The method of claim 1, wherein the NiFe₂O₄ nanoparticles have an irregular shape.

5. The method of claim 1, wherein the NiFe₂O₄ nanoparticles have a spherical shape.

6. The method of claim 1, wherein the NiFe₂O₄ nanoparticles comprise 15-25 wt. % O, 45-55 wt. % Fe, and 30-35 wt. % Ni, based on a total weight of the NiFe₂O₄ nanoparticles.

7. The method of claim 1, wherein the NiFe₂O₄ nanoparticles comprise phenolic compounds on a surface.

8. The method of claim 1, wherein the calcining removes phenolic compounds from a surface of the NiFe₂O₄ nanoparticles, and
wherein the surface of the NiFe₂O₄ nanoparticles has negatively charged hydroxyl groups.

9. The method of claim 1, wherein the NiFe₂O₄ nanoparticles have a saturation magnetization of 25-35 emu/g at 300K.

10. The method of claim 1, wherein the aloe vera extract is made by a method comprising:
cutting aloe vera leaves into pieces having a longest dimension of less than 1 cm;
mixing the pieces in water and boiling the pieces for at least 5 min to form an extract mixture; and
separating the pieces from the extract mixture to form the aloe vera extract.

11. The method of claim 1, wherein in the contacting the NiFe₂O₄ nanoparticles have a concentration of 0.125-1 mg per mL of the biofilm.

12. The method of claim 1, wherein on the contacting the NiFe₂O₄ nanoparticles have a minimum inhibitory concentration (MIC) of 1.6-2 mg per mL of the biofilm.

13. The method of claim 1, wherein the biofilm comprises at least one selected from the group consisting of Methicillin-resistant Staphylococcus aureus (MRSA), Candida albicans, and Pseudomonas aeruginosa.

14. The method of claim 1, wherein in the contacting the NiFe₂O₄ nanoparticles have a concentration of 0.5 mg per mL of the biofilm, and
wherein the NiFe₂O₄ nanoparticles reduce an amount of a Candida albicans biofilm by at least 50% 24 h after the contacting,

15. The method of claim 1, wherein in the contacting the NiFe₂O₄ nanoparticles have a concentration of 0.5 mg per mL of the biofilm, and
wherein the NiFe₂O₄ nanoparticles reduce an amount of a Pseudomonas aeruginosa biofilm by at least 50% 24 h after the contacting,

16. The method of claim 1, wherein in the contacting the NiFe₂O₄ nanoparticles have a concentration of 0.5 mg per mL of the biofilm, and
wherein the NiFe₂O₄ nanoparticles reduce an amount of a MRSA biofilm by at least 70% 24 h after the contacting,

17. The method of claim 1, wherein the surface is in a hospital.

18. The method of claim 1, wherein the NiFe₂O₄ nanoparticles attach to a cell surface and at least partially penetrate and distort a membrane of the cell in the biofilm leading to cell death.

19. The method of claim 1, further comprising:
functionalizing a surface of the NiFe₂O₄ nanoparticles with an antibacterial compound prior to the contacting,
wherein the antibacterial compound is covalently bound to the surface of the NiFe₂O₄ nanoparticles.

20. The method of claim 1, further comprising:
functionalizing a surface of the NiFe₂O₄ nanoparticles with a photosensitizer prior to the contacting, and
irradiating the NiFe₂O₄ nanoparticles with a photosensitizer after the contacting to form reactive oxygen species,
wherein the photosensitizer is covalently bound to the surface of the NiFe₂O₄ nanoparticles.
